(19) United States
(12) Patent Application Publication
(10) Pub. No.: US 2010/0275200 A1
(43) Pub. Date: Oct. 28, 2010

(54) Interface for Virtual Machine Administration in Virtual Desktop Infrastructure

(75) Inventors: Ramesh Radhakrishnan, Austin, TX (US); Ronald Pepper, Hutto, TX (US); Arun Rajan, Austin, TX (US)

Correspondence Address: LARSON NEWMAN & ABEL, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 12/427,825

(22) Filed: Apr. 22, 2009

(51) Int. Cl. G06F 9/455

(52) U.S. Cl. 718/1

(57) ABSTRACT

A system includes a plurality of virtualization servers and a virtual desktop interface. The plurality of virtualization servers are configured to be placed in communication with a client. The virtual desktop interface is in communication with the plurality of virtualization servers and with the client. The virtual desktop interface is configured to receive a request for maintenance from the client, and further configured to perform the request for the maintenance on one of the virtualization servers associated with the client.

### FIELD OF THE DISCLOSURE

This disclosure relates generally to information handling systems, and more particularly relates to an interface for virtual machine administration in a virtual desktop infrastructure.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

A virtual desktop infrastructure (VDI) solution enables virtualized personal computers (PCs) and computer desktops to run as virtual client desktops on virtualization servers located inside a data center. These virtualization servers host and connect the virtual client desktop to, in many cases, a thin client. A thin client is an endpoint for attaching user peripherals, such as the monitor, mouse, and keyboard.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a computer network;

FIG. 2 is a block diagram of a virtual desktop infrastructure system;

FIG. 3 is a schematic diagram of an exemplary screen shot of a virtual desktop in the virtual desktop infrastructure system;

FIG. 4 is a flow diagram of a method for providing maintenance support for a virtual desktop of a client;

FIG. 5 is a flow diagram of another method for providing maintenance support for a virtual desktop of a client; and

FIG. 6 is a block diagram of a general computer system.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application.

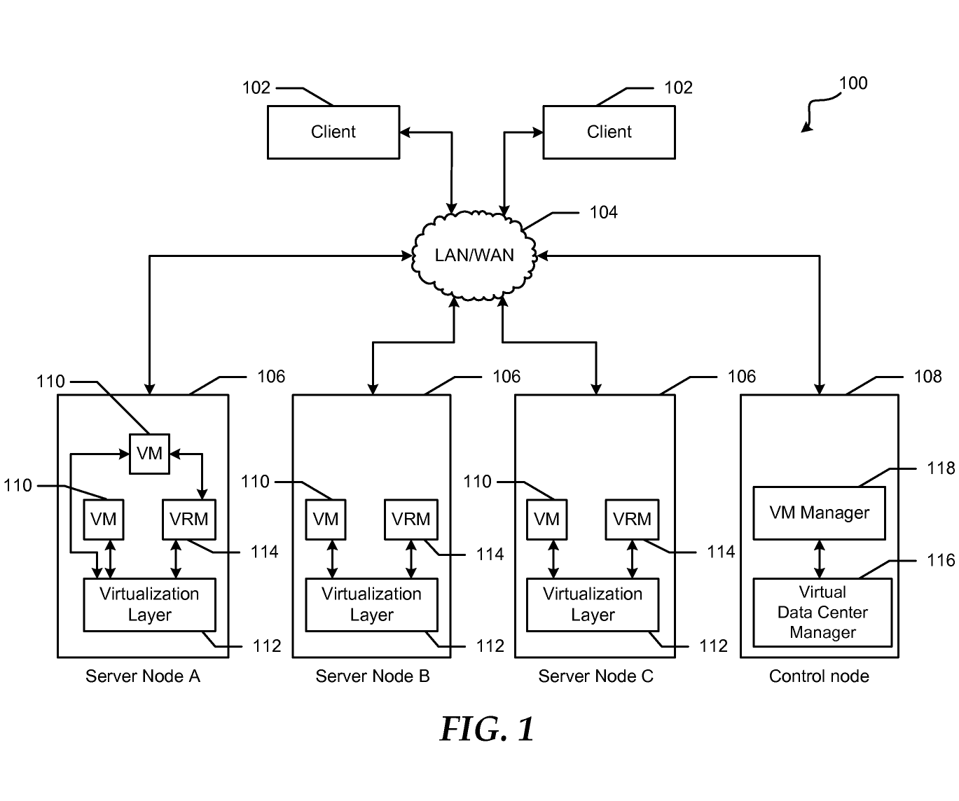

FIG. 1 shows a server cluster network 100 of an information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

Server cluster network 100 includes client nodes 102, a LAN or WAN node 104, server nodes 106, and a control node 108. The servers 106 include virtual machines 110, a virtualization layer 112, and a virtual resource manager 114. The control node 108 includes a virtual data center manager 116 and a virtual machine manager 118. The client nodes 102 are coupled to the LAN or WAN node 104, which in turn is coupled to the server nodes 106, such as Server Node A, Server Node B, and Server Node C, and to the control node 108.

The servers 106 can perform any server function and may comprise, for example, data servers, application servers, or web servers. Each of the server nodes 106 will be referred to herein as physical nodes or servers to contrast these nodes with the virtual machines 110 running on each of the servers. The virtualization layer 112 separates the hardware and software of the physical server that supports the virtual machines 110 running on the server 106. The virtualization layer 112 includes the hardware of the server 106, the operating system of the server, and the virtual system software that runs on the operating system of the server and supports each virtual machine 110 of the server. As indicated in each of the servers 106, the virtual machine 110 is supported by and communicates with the virtualization layer 112.

The virtual resource manager 114 controls the amount of physical resources of the server 106 that are being allocated to each of the virtual machines 110 hosted by the server. These physical resources that are rationed by the virtual resource manager 114 include the processing capacity of the processor or processors of the server 106 and the memory of the server 106. The virtual resource manager 114 also maintains a record of the resource utilization requirements of each virtual machine 110 of the associated server 106. The resource requirement of each virtual machine 110 of a server 106 is the maximum amount of resources that, depending on the operational status of the virtual machine, could be consumed by the virtual machine. The virtual resource manager 114 is also able to identify the total resource utilization of the server 106. The total resource utilization of a server 106 is a snapshot of the resource utilization of the server. The total resource utilization of a server 106 can be expressed as a percentage of the maximum possible resource utilization of the server. Each virtual machine 110 is able to exchange data with the virtual resource manager 114 of the server 106. Also, each virtual machine 110 and the virtual resource manager 114 of the server 106 communicate with the virtualization layer 112 of the server.

The virtual data center manager 116 of the control node 108 operates in a centrally accessible location in server cluster network 100 and receives from each of the virtual resource managers 114 of each of the servers 106 (a) the resource utilization requirements of each of the virtual machines 110 within server cluster network and (b) the total resource utilization of each server. The resource utilization requirements of each virtual machine 110 and the total resource utilization of each server 106 comprise a global resource map that identifies for the virtual data center manager 116 the resources required by each of the virtual machines and the resources currently being consumed by each of the physical servers of the computer network. The virtual machine manager 118 communicates with the virtual data center manager 116 and upon receiving a command from virtual data center manager, is operable to migrate a virtual machine 110 from a first physical server to a second physical server.

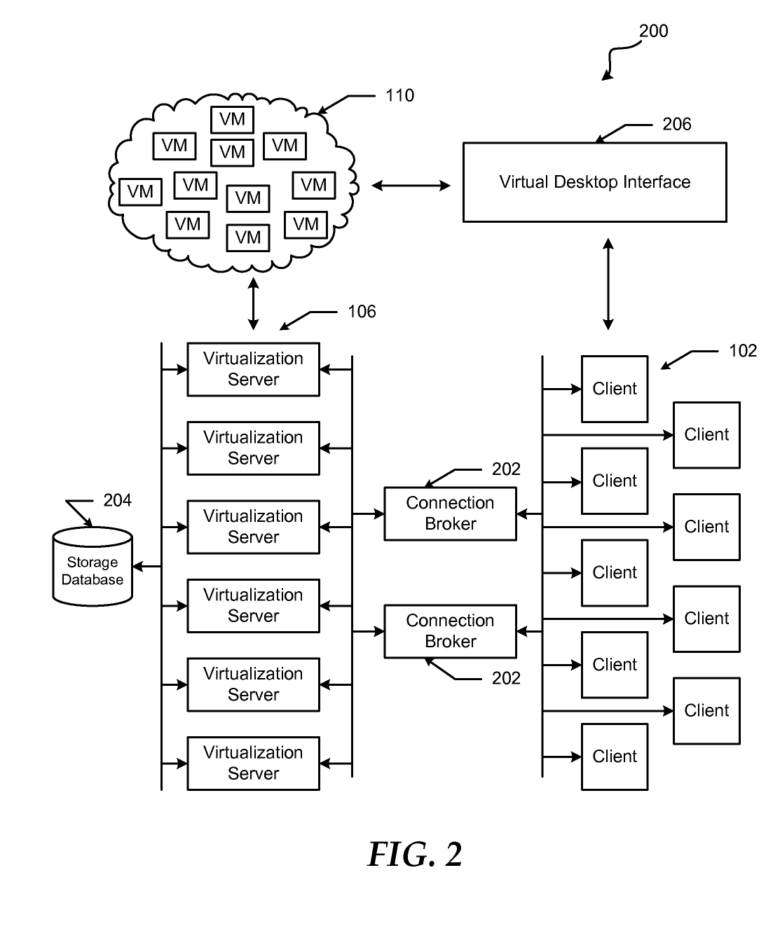

FIG. 2 shows a virtual desktop interface (VDI) 200 of the server cluster network 100 of FIG. 1. The VDI 200 includes connection brokers 202, a storage database 204, a virtual desktop interface 206, the clients 102, virtualization servers 106, and virtual machines 110. The connection brokers 202 can be part of the LAN/WAN node 104 of FIG. 1. Each of the clients 102 are in communication with the connection brokers 202, the virtualization servers 106, the storage database 204, the virtual machines 110, and the virtual desktop interface 206. The connection brokers 202 are in communication with each of the virtualization servers 106, which are in communication with the storage database 204 and with the virtual machines 110. The clients 102 can each be assigned a specific amount of memory, a specific amount of the storage space, a specific amount of processor speed, specific applications, and the like of the virtualization servers 106 and the storage database 204.

The clients 102 can be endpoints of the VDI 200 for attaching user peripherals, such as a monitor, a mouse, and/or a keyboard. The connection brokers 202 can provide the clients 102 with access to the virtualization servers 106, the storage database 204, and the virtual machines 110. The virtualization servers 106 can perform the processing functions for the clients 102 via the virtual machines 110, and each of the virtual machines can be assigned to one of the clients. The virtual desktop interface 206 can perform maintenance on the virtual machines 110, can assign different virtual machines to different clients 102, can provide trouble tickets to information technology (IT) administrators, and the like. If a trouble ticket is submitted, the IT administrator can review the trouble ticket and then can access the virtual client desktop and the virtualization servers to correct the problem with the virtual client desktop. The IT administrator can also set different request authorization levels in the virtual desktop interface 206. For example, the different request authorization levels can be which requests associated with the clients 102 and the virtual machines 110 can be handled by the user via the client 102 and the virtual desktop interface 206, and which requests can be approved by the IT administrator of the VDI 200. The different requests can be implemented automatically in the virtual desktop interface 206 through hardware, software, or any combination of hardware and software.

A user can log into the client 102 and can use the client to access the virtualization servers 106 and the storage database 204 via one of the connection brokers 202. The client 102 can only access the resources of the virtualization servers 106 and the storage database 204 available through the virtual machine 110 assigned to the client. The virtual machine 110 can be displayed as a desktop image on the client 102. The desktop image can include the applications, the storage, and the processing capacity available to the virtual machine 110 of the client 102. Thus, as the user logs into the client 102, the desktop image of the virtual machine 110 can be displayed to the user.

The user can make an upgrade request to the virtual desktop interface 206 such that the client 102 can be allocated more resources, such as higher processing, more memory reservations, and the like. Depending on the upgrade request, the virtual desktop interface 206 can either allow the upgrade automatically, or can submit an upgrade ticket to be reviewed for approval by the IT administrator. For example, if the computing power of the current virtual machine 110 is not sufficient, the user may want to switch to a different virtual machine having more processing power. In this situation, the virtual desktop interface 206 can submit an upgrade ticket to be approved by the IT administrator. However, if the upgrade request is for a larger memory reservation of the storage database 204, the virtual desktop interface 206 can automatically roll over the client 102 to a new virtual machine 110 that is allocated the necessary amount of storage space with approval from the IT administrator.

The user can also access the virtual desktop interface 206 to request a snapshot of the current desktop image for the client 102. The virtual desktop interface 206 can store the desktop image as a separate virtual machine 110 of the virtualization servers 106. Thus, the virtual desktop interface 206 uses the snapshot to create a new virtual machine 110 with the same resource requirements of the server 106, such as the same processing capacity and the same memory reservations, as the current virtual machine. After having a stored snapshot of the desktop image, if the desktop image becomes damaged, the user may use the virtual desktop interface 206 to discard the current desktop image and to roll over to the previously saved snapshot of the client desktop image without losing data.

The desktop image may become corrupted or otherwise encounter a problem that prevents the user from accessing the virtualization server 106 through the virtual machine 110. In this situation, the user can make a maintenance request for the desktop image of the client 102. The maintenance request can be sent from the client 102 to the virtual desktop interface 206. Depending on the maintenance request, the virtual desktop interface 206 can either fix the problem with the desktop image, or can submit a trouble ticket to be reviewed for approval by the IT administrator. For example, if the maintenance request is for a new desktop image associated with the a different virtual machine 110, the virtual desktop interface 206 can automatically discard the virtual machine associated with the client and can assign a new virtual machine and desktop image with the same resources to the client 102 or can roll the desktop image over to a stored desktop image snapshot.

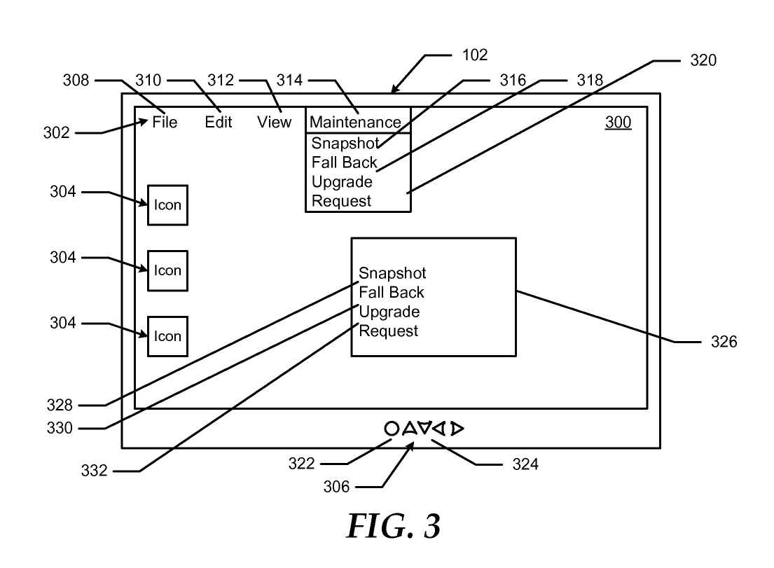

FIG. 3 shows an exemplary diagram of a screen shot 300 of the client 102 including a menu bar 302, desktop icons 304, and a maintenance button 306. The menu bar 302 includes a file menu 308, an edit menu 310, a view menu 312, and a maintenance menu 314. Each of the menus of the menu bar 302 can be selected and a drop down menu of options can be provided. For example, the maintenance menu 314 can provide the user with a snapshot option 316, a fallback option 318, and an upgrade request option 320. The maintenance buttons 306 include a select button 322 and directional arrows 324. When the select button 322 of the maintenance buttons 306 is pressed, a selection menu 326 can be displayed including a snapshot option 328, a fallback option 330, and an upgrade request option 332.

The user of the client 120 can either make a maintenance request via the maintenance menu 318 of the menu tool bar 302 or by pressing the select button 322 of the maintenance buttons 306. The user can use the directional arrows 324 to highlight one of the options within the selection menu 326. Upon highlighting the desired option, the user can press the select button 322 and send the request to the virtual desktop interface 206. Alternatively, the user can utilize a mouse or another pointing device to drop down the maintenance menu 314. The user can then select one of the options within the maintenance menu 314, and then send the request to the virtual desktop interface 206.

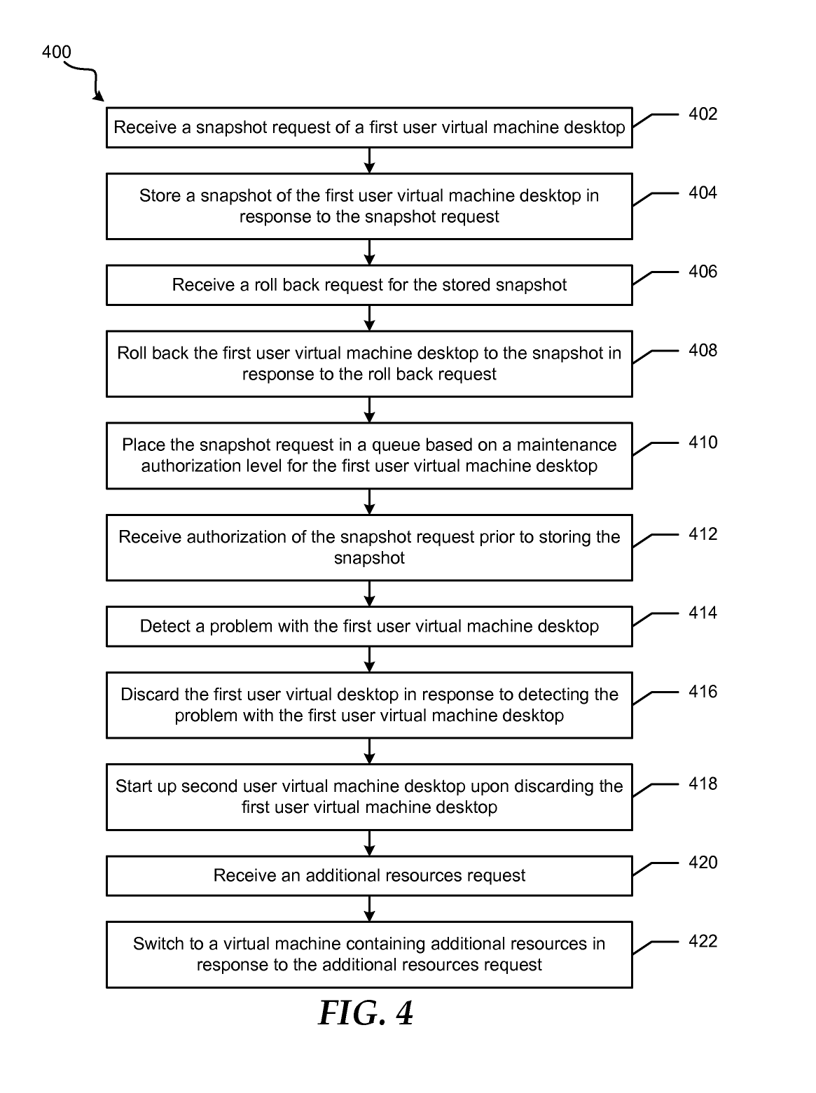

FIG. 4 shows a method for providing maintenance support for a virtual desktop of a client. At block 402, a snapshot request of a first user virtual machine desktop is received. A snapshot of the first user virtual machine desktop is stored in response to the snapshot request at block 404. At block 406, a roll back request for a stored snapshot is received. The first user virtual machine desktop is rolled back to the stored snapshot in response to the roll back request at block 408. At block 410, the snapshot request is placed in a queue based on a maintenance authorization level for the first user virtual machine desktop.

The authorization of the snapshot is received prior to storing the snapshot at block 412. At block 414, a problem is detected with the first user virtual machine desktop. The first user virtual desktop is discarded in response to detecting the problem with the first user virtual machine desktop at block 416. At block 418, a second user virtual machine desktop is started up upon discarding the first user virtual machine desktop. An additional resources request is received at block 420. At block 422 the client is switched to a virtual machine containing additional resources in response to the additional resource request.

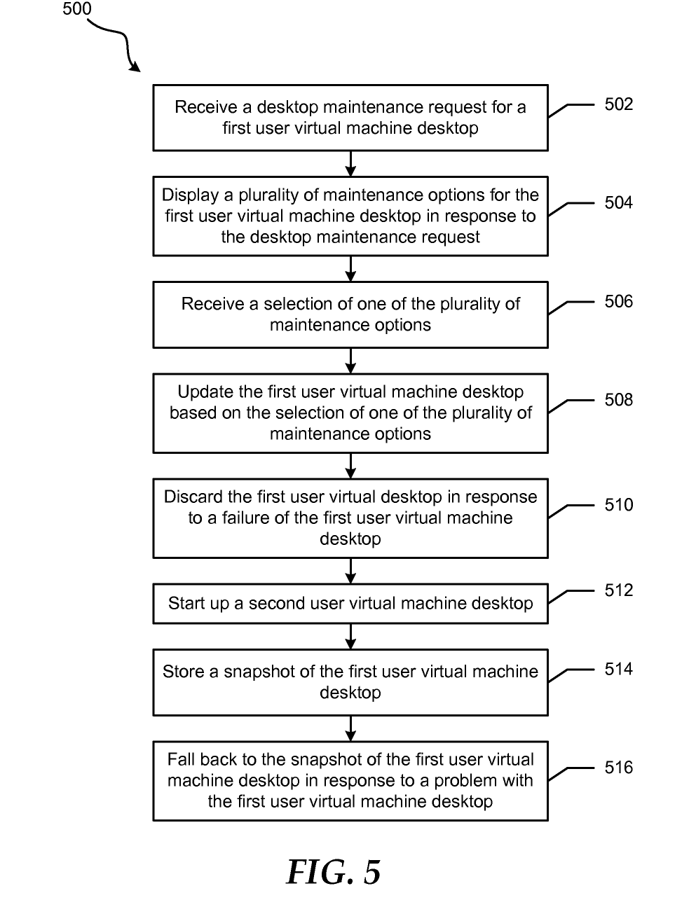

FIG. 5 shows another method 500 for providing maintenance support for the virtual desktop of the client. At block 502, a desktop maintenance request is received for a first user virtual machine. A plurality of maintenance options are displayed for the first user virtual machine desktop in response to the desktop maintenance request at block 504. At block 506, a selection of one of the plurality of maintenance options is received. The first user virtual machine desktop is updated based on the selection of one of the plurality of maintenance options at block 508. At block 510, the first user virtual desktop is discarded. A second user virtual machine desktop is started up at block 512. At block 514, a snapshot of the first user virtual machine desktop is stored. The client falls back to the snapshot of the first user virtual machine desktop in response to a problem with the first user virtual machine desktop at block 516.

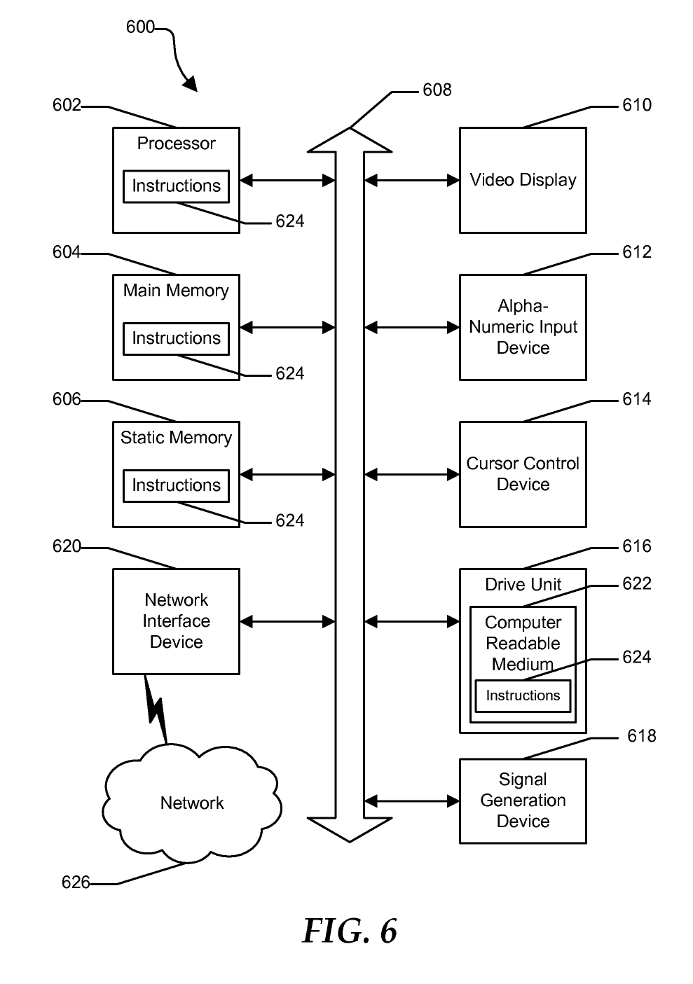

FIG. 6 shows an illustrative embodiment of a general computer system 600 in accordance with at least one embodiment of the present disclosure. The computer system 600 can include a set of instructions that can be executed to cause the computer system to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A computer readable medium comprising a plurality of instructions to manipulate a processor, the plurality of instructions comprising:
instructions to receive a request for a snapshot of a first user virtual machine desktop;
instructions to store the snapshot of the first user virtual machine desktop in response to the request for the snapshot;
instructions to receive a request for a roll back to the stored snapshot; and
instructions to roll back the first user virtual machine desktop to the snapshot in response to the request for the roll back.

2. The computer readable medium of claim 1 further comprising:
instructions to place the request for the snapshot in a queue based on a maintenance authorization level for the first user virtual machine desktop; and
instructions to receive authorization of the request for the snapshot prior to storing the snapshot.

3. The computer readable medium of claim 1 further comprising:
instructions to detect a problem with the first user virtual machine desktop;
instructions to discard the first user virtual machine desktop in response to detecting the problem with the first user virtual machine desktop; and
instructions to start up a second user virtual machine desktop upon discarding the first user virtual machine desktop.

4. The computer readable medium of claim 4 wherein the problem includes a corruption of a current image in the first user virtual machine desktop.

5. The computer readable medium of claim 1 further comprising:
instructions to receive a request for additional resources; and
instructions to switch to a virtual machine containing additional resources in response to the request for the additional resources.

6. The computer readable medium of claim 5 wherein the additional resources includes more memory reservations, a higher central processor unit, and more computing power.

7. The computer readable medium of claim 1 wherein a different plurality of user virtual machines are located on each of a plurality of virtualization servers.

8. A method comprising:
receiving a request for a desktop maintenance for a first user virtual machine desktop;
displaying a plurality of maintenance options for the first user virtual machine desktop in response to the request for the desktop maintenance;
receiving a selection of one of the plurality of maintenance options; and
updating the first user virtual machine desktop based on the selection of the one of the plurality of maintenance options.

9. The method of claim 8 further comprising:
discarding the first user virtual machine desktop in response to a failure of the first user virtual machine desktop; and
starting up a second user virtual machine desktop.

10. The method of claim 8 further comprising:
instructions to store a snapshot of the first user virtual machine desktop; and
instructions to fall back to the snapshot of the first user virtual machine desktop in response to a problem with the first user virtual machine desktop.

11. The method of claim 8 wherein the request for the desktop maintenance is a request for additional resources for the first user virtual machine.

12. The method of claim 8 wherein the request for the desktop maintenance is in response to a desktop image being corrupted.

13. The method of claim 8 wherein the request for the desktop maintenance is provided from a hardware maintenance button.

14. A system comprising:
a plurality of virtualization servers configured to be placed in communication with a client; and
a virtual desktop interface in communication with the plurality of virtualization servers and with the client, the virtual desktop interface configured to receive a request for maintenance from the client, and further configured to perform the request for the maintenance on one of the virtualization servers associated with the client.

15. The system of claim 14 further comprising:
a storage database in communication with the plurality of virtualization servers, the storage database configured to store data from the plurality of virtualization servers.

16. The system of claim 14 further comprising:
a connection broker in communication with the plurality of virtualization servers and with the client, the connection broker configured to initiate communication between the client and the virtualization servers.

17. The system of claim 14 wherein the request for the maintenance is a request for a snapshot for a virtual desktop of the client.

18. The system of claim 14 wherein the request for the maintenance is a request for a fall back for the client.

19. The system of claim 14 wherein the virtual desktop interface is further configured to discard a first virtual desktop of the client and to provide a second virtual desktop of the client in response to the request for the maintenance.

20. The system of claim 14 wherein the virtual desktop interface is further configured to provide the client more resources including an allocation of more memory and an allocation of more processor.
